(19) United States
(12) Patent Application Publication
(10) Pub. No.: US 2014/0241173 A1
(43) Pub. Date: Aug. 28, 2014

(54) Method for routing data over a telecommunications network

(71) Applicant: Erik J. Knight, Phoenix, AZ (US)

(72) Inventor: Erik J. Knight, Phoenix, AZ (US)

(21) Appl. No.: 14/271,711

(22) Filed: May 7, 2014

Related U.S. Application Data
(63) Continuation-in-part of application No. 13/472,993, filed on May 16, 2012, now abandoned.

(51) Int. Cl. H04M 7/00; H04L 12/775; H04L 12/26

(52) U.S. Cl. CPC H04M 7/0075; H04L 43/0811; H04L 45/58
USPC 370/248

(57) ABSTRACT

An improved communication system in which routing of data packet follows a preferred path through the Internet. Data packets are repacked with preferred IP addresses according to routing tables provided by a monitoring facility. The repackaging data packets are sent through a public network, such as the Internet, utilizing strategically located routers which are controlled by the monitoring facility, thereby creating a preferred network routing system within the public network.

### CROSS REFERENCE TO RELATED APPLICATIONS

This application is a continuation in part of U.S. application Ser. No. 13/472,993, filed May 16, 2012. The previous application is incorporated entirely by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed to improved and reliable communications for a VoIP (Voice over Internet Protocol) system by intelligent routing via the collection of data.

(2) Description of Related Art

Phone systems used to be based on a Public Switched Telephone Network (PSTN). Land lines were connected to the PSTN through hard a wired network system. An end user would dial a number for a phone, and the PSTN would recognize the dialing number and provide the connecting service between the two endpoints.

Currently, phones can be connected to each other through the World Wide Web (Internet) utilizing VoIP to communicate between end users. Phones which are attached to the Internet digitize the speech at the transmitting end, and route the voice as data packets, much like any other data packet that is routed over the Internet. The endpoint phones are connected to the Internet through a local ISP which connects to higher level ISPs with broader Internet access.

As a practical matter, VoIP communications are mixed in with other data transmissions on the Internet. Current protocol for routing is based on the endpoint IP address being placed on the data package as part of the header, and the data package is routed based on routing tables established in each connecting router. While the data package will eventually get to the end destination, sometimes it is not timely or gets lost due to transmission errors.

The routing tables in each connecting router play a key role in timely delivery, and also the quality of transmission. Once a data package is sent through the public Internet, the endpoint users lose control of how it is delivered. Commercial/public routers may have a number of criterions for setting up routing delivery path tables. There may be commercial/contract issues in place between communication companies. There may be issues with affordability between path choices.

There are security concerns related to commercial/public routers as the method of identifying the most efficient path is based on trust between the connected ISPs. A router will inform the other neighbor routers which paths are available, and the other routers add it to their routing tables. If a router is intentionally re-configured by a malicious party, this allows for routers to send data to another continent and back. This ‘trust based’ routing method allows for cyber-attacks from companies who use man in the middle type of attacks.

VoIP transmissions have to compete with other data packages being routed, such as web pages, email, Internet downloads, etc. The companies that transmit data over the Internet have their own reasons for routing data, which include: contracts in place, affordability of routing, maintenance being performed on the system, timeliness, and unexpected outages, among other things.

The issues related to data packet routing causes phone to phone communication problems. The most common problems are delays (i.e. data pauses between phone users due to routing distances or retransmission between intermediate points due to transmission errors), weird sounds, noise, and echo. A phone user can sometimes hear their own voice (echo) slightly delayed after they speak. Also, some data packets can be lost due to transmission errors between intermediate points and current protocol includes a ‘drop the data’ based on a maximum count when the transmission will not work. When delay problems occur, it causes voice to voice communications to become garbled, at low fidelity, or lost.

In a typical case, a VoIP connection is established to a local ISP and is used to transmit data to or from areas of the Internet beyond the home network. This method of interconnecting is repeated to connect to a Tier 2 carrier, and eventually to a Tier 1 carrier. This process may include multiple connections. The transmission of data is complicated in that a Tier 1 or Tier 2 carrier may be connected to other lower level carriers. Tier 1 or Tier 2 ISPs may engage in peering, routing data without charging one another, rather than transmit through a higher Tier ISP where a cost would be incurred.

In an effort to reduce the number of hops (the hop count) a data packet makes during transit, some networks attempt to utilize static routing tables, which provide routing instructions to a network router at the initial endpoint, determining the network path for transmission of the packet. These static routing tables are frequently determined solely by hop count, with little regard to network latency and packet loss. Due to this constraint, static routing tables fail to take into account changes in network traffic and node reliability, thus creating suboptimal routes for packet transmission.

VoIP communication is generally viewed as less reliable than the standard hardwired circuit-switched public telephone network because there is no network-based mechanism that ensures VoIP data packets are delivered in sequential order and are not lost. It is a best-effort network without Quality of Service (QoS) guarantees. VoIP faces problems with latency, varying latency, and data packet loss.

Some networks utilize multiprotocol label switching (MPLS) as an alternative to static routing tables. In an MPLS system, routes are provided with labels, allowing packets to be assigned routes based on the class of service associated with the packet. In order to effectively provide labels for routes from one endpoint to another, MPLS is restricted to private networks where the possible paths from one endpoint to another are known. This creates difficulty for multisite data network deployment, since new sites would require extensive configuration to connect to a MPLS network.

As a practical matter, a MPLS data packet switching system is not widely available on the Internet due to the type of header used, which is not recognized by public routers on the Internet. The ability to explicitly route a data packet on the Internet by such a system is not a reliable method as currently practiced.

Internet service providers (ISPs) monitor the transmission of their own communication systems and re-route communications between points to avoid issues related to data packet problems, such as timing and loss. Monitoring systems are in place to detect issues and provide corrections. Their monitoring and rerouting systems are often efficient. However, the financial incentives to keep costs down for ISPs may overweigh what is needed for high levels of quality VoIP communication.

Phone communications are different that many other data communications in that they are critical with respect to timeliness and quality. A phone conversation is frustrating and difficult if there are pauses, echoes, garbled speech, and unwanted noises on the phone. It is also unsatisfactory from a user standpoint for the phone conversation to be interrupted or lost; causing an end user to frequently repeat what was said. Other Internet data packets are not so time critical, such as loading web pages, email, and downloading files. These are relatively large files to manage, and the ISPs will concentrate on efficient routing of these relatively large volumes.

Others have worked on efficiency of transmission between Internet endpoints. For example U.S. Pat. No. 7,240,124 describes routing via a route optimizer method where information is received from optimized routers and plurality of routers with regard to traffic congestion. This method is designed for extremely high transfer rates (bandwidth) over 10 Gb/sec and short wait times of 1 millisecond which is many times higher and more demanding than VoIP requires. This does not address the transfer of VoIP packets and the optimization needed for transmittal of relatively small data streams from a wide variety of locations to a similarly wide variety of locations.

Others have worked on efficiency of transmission between Internet endpoints. For example U.S. Pat. No. 7,240,124 describes routing via a route optimizer method where information is received from optimized routers and plurality of routers with regard to traffic congestion. This method is designed for extremely high transfer rates (bandwidth) over 10 Gb/sec and short wait times of 1 millisecond which is many times higher and more demanding than VoIP requires.

This does not address the transfer of VoIP packets and the optimization needed for transmittal of relatively small data packet streams passing between a large variety of source and destination endpoint locations. Approximately 21-87 kbps bandwidth is common for voice calls, delivering 33-50 packets per second. A video connection, such as used in video conferences, commonly requires between 128 Kbps to 512 Kbps bandwidth using compression technologies.

A solution is needed to address these shortcomings in the art to improve the reliability and quality of VoIP and video communications. A more robust and more certain method of optimizing the transfer of VoIP packets is needed.

### BRIEF SUMMARY OF THE INVENTION

The present invention provides a system in which data packet routing follows a preferred path that is provided by repackaging data packets and routing the data through a public network, utilizing a strategically located VoIP router system, thereby creating a preferred network routing system within the public network.

Data is collected on the Internet from an operating VoIP system that is used to optimize transmission between points on the network. The VoIP provider deploys privately owned VoIP routers to transmit the VoIP data packets. The VoIP routers are positioned at the end points, and additionally on the Internet at strategic locations, to monitor and collect VoIP transmission data so as to route the VoIP data packages efficiently according to factors such as quality and timeliness. The VoIP routers are then provisioned to transmit the VoIP data packets on a preferred route by labeling the VoIP data packets to direct them via the preferred route. To some extent, the communication between endpoints can be treated as though they are on a local network as the public routers have less much control over the path of the data packets on the Internet. In this manner, a higher level of intelligence is added to the overall VoIP system to protect it and make it more efficient.

In the VoIP preferred network routing system, VoIP routers are deployed to multiple sites. When the routers connect to the Internet, they send their network location to a VoIP monitoring facility. The monitoring facility then stores the router's network location. The monitoring facility monitors the data packets routed between various endpoints, as well as continually testing the connections, to collect information regarding packet loss, latency, and hop count.

After collecting packet loss, latency, and hop count information, the monitoring facility determines optimum paths for data packet traffic through the Internet, or between endpoints. These paths are prioritized, such that higher priority routes have a reduced latency and risk of packet loss, while maintaining quality of service (QOS) requirements for a particular class of service (COS). These paths are organized into dynamic routing tables, which are passed to the VoIP routers connected to the preferred network. The routers then utilize the dynamic routing tables to direct network traffic, which establishes the preferred network routing system.

The monitoring facility frequently retests connections between the various endpoints. After each successive test of the data connections, the monitoring facility reconstructs the dynamic routing tables. The monitoring facility then passes the updated dynamic routing tables to the network routers, allowing the network routers to maintain a stable data connection with other endpoints on the network.

### BRIEF DESCRIPTION OF THE SEVERAL VIEWS OF THE DRAWING(S)

FIG. 1 shows an embodiment of the invention.

FIGS. 2A-2B show IPv4 and IPv6 IP Packet-header format, respectively, for a non-multiprotocol label switching currently in use.

FIG. 3 shows the Internet Open Systems Interconnection (OSI) model layers currently in use.

FIGS. 4 and 5 show an embodiment for VoIP routers that are connected to the Internet, and the use of a central monitoring facility to control communications to all VoIP routers.

FIG. 6 illustrates how a router avoids an Internet path and reroutes a data packet through an alternate

### DETAILED DESCRIPTION OF THE INVENTION

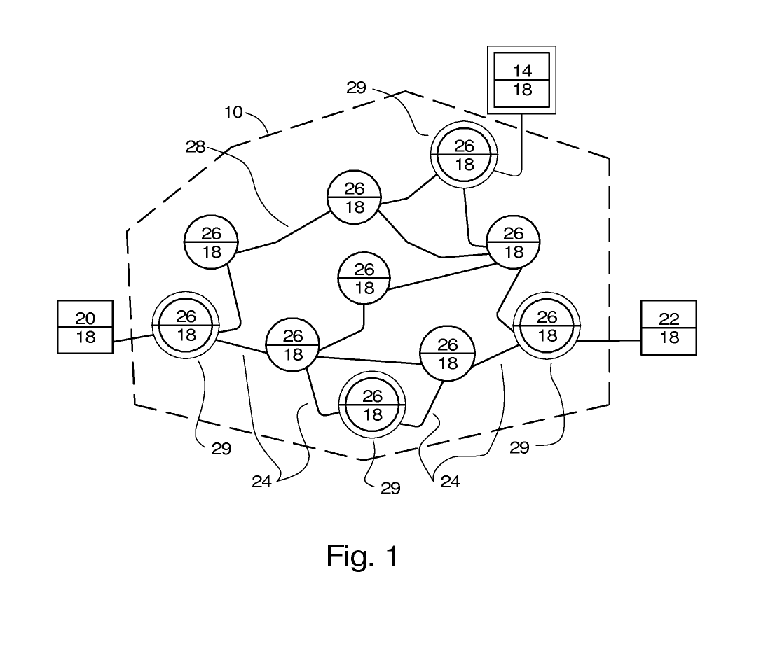

In FIG. 1, the system for preferred network routing 24 comprises a data network 10, such as the Internet, and a monitoring facility 14. The data network 10 connects a first endpoint 20, a final endpoint 22, by use of multiple nodes or routers 26, and multiple data connections 28 connecting the first endpoint 20, the final endpoint 22, and nodes 26. The first endpoint 20, final endpoint 22, and nodes 26 are each equipped with a router 18. Each of the first endpoint 20, final endpoint 22, and nodes 26 are typically located at the different sites, but are possibly located at the same site. The data connections 28 may be T1, 3G, 4G, cable, fiber, DSL, or other high speed broadband connection. The data connections 28 may be public, private, or a combination of both.

After a private VoIP router 29 is connected to the data network 10 by means of a data connection 28 and receives a network address, the router 18 transmits its network address and other identifying information, such as hardware identification (HWID) and network identification (NID), to a monitoring facility 14. The monitoring facility 14 then stores the network address of the router 18 in a database for use in establishing dynamic routing tables within the data network 10.

The monitoring facility 14 tests the data connections 28 between various endpoints 20, 22 and nodes 26 on the data network 10, collecting information regarding packet loss, latency, and hop count. This may be accomplished by sending test data packets through various data connections 28 and nodes 26. Upon receiving the test data packets, the monitoring facility 14 can calculate data network 10 information, such as latency and data packet loss, attributable to specific data connections 28.

After collecting the data network 10 information, the monitoring facility 14 is able to determine a preferred path 24 between the source endpoint 20 and final destination endpoint 22, as well as prioritize less preferred paths through the data connections 28. A preferred path 24 may be preferred due to a low hop count, low latency, low packet loss, effect on quality of service, or other considerations for a given class of service (COS). This process is repeated for each of the endpoints 20, 22, and nodes 26 on the data network 10.

The monitoring facility 14 compiles these preferred paths 24 and data connections 28 in a dynamic routing table. The dynamic routing table is distributed to the VoIP routers 29 by means of push data, or the routers 29 request the information directly from the monitoring facility 14.

The monitoring facility 14 continually tests the data connections 28. As changes are found, the dynamic routing tables are updated to reflect changes in the environment or data network 10. As these dynamic routing tables are updated, the information is passed to the VoIP routers 29.

The automatic updating of the dynamic routing tables allows the VoIP routers 29 to update the preferred path 24 and assign a preferred path 24 to transmitted data packets within the data network 10.

The continual testing of the data connections 28 and updating of the dynamic routing tables allow a node 26 to be removed or inserted in the table with minimal effect to the endpoints 20, 22.

Optionally, identifying information sent from the VoIP router 29 to the monitoring facility 14 which may include hardware temperature, memory usage, VoIP router 29 uptime, and bandwidth usage. System administrators may be able to access the identifying information through a webserver hosted in the monitoring facility 14 or within an endpoint 20, 22, or node 26.

The Internet will route the payload between the source and destination network addresses based on the protocols of the various ISPs nodes 26 through packet switching. Nodes 26 with routing tables that are not controlled by the monitoring facility 14 will transmit data based on algorithms which may or may not be advantageous to the transmission of VoIP data packets.

One significant embodiment of the invention, is the ability to add ‘virtual routers’ to the system to improve monitoring and routing table calculations. A virtual router is a software router that is located in a data network from a cloud based system data transfer system. The use of this kind of router allows the monitoring facility to obtain additional information about data transfer through the Internet very easily and affordability, without having to travel to a particular location and wire a VoIP router into the system. A cloud based virtual router is easily purchasable from a third party and added through the Internet, and can be taken off the system when no longer needed. This kind of router does not actually transmit data packets.

A VoIP packet that is sent through the Internet is broken down into three sections: a header, a payload (i.e. user data), and a trailer. The header and trailer contain control information which provides the Internet what is needed to deliver the payload. The header will include source and destination network addresses, error detection codes, and sequencing information.

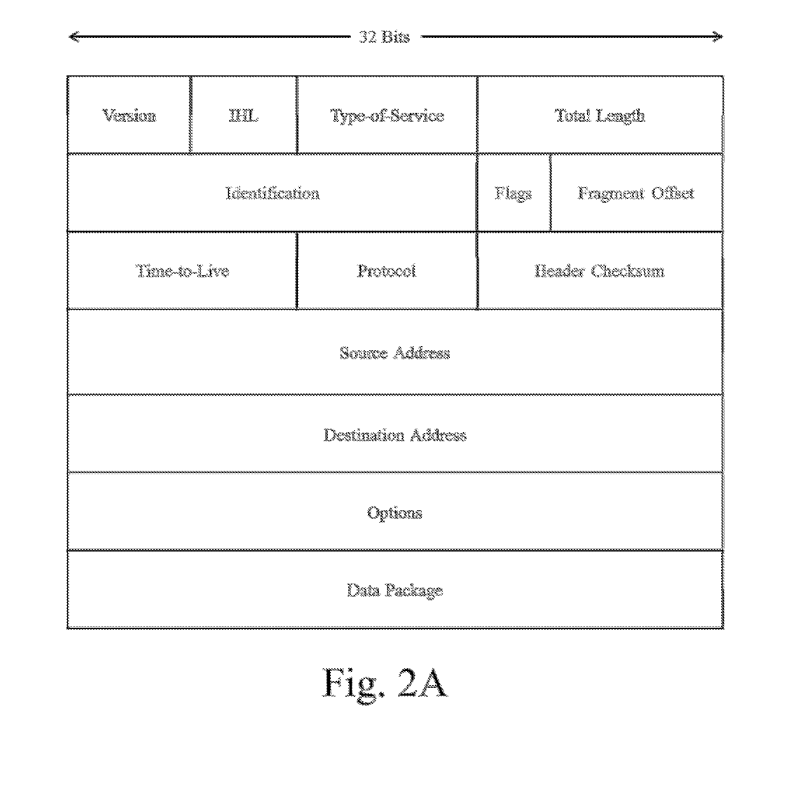

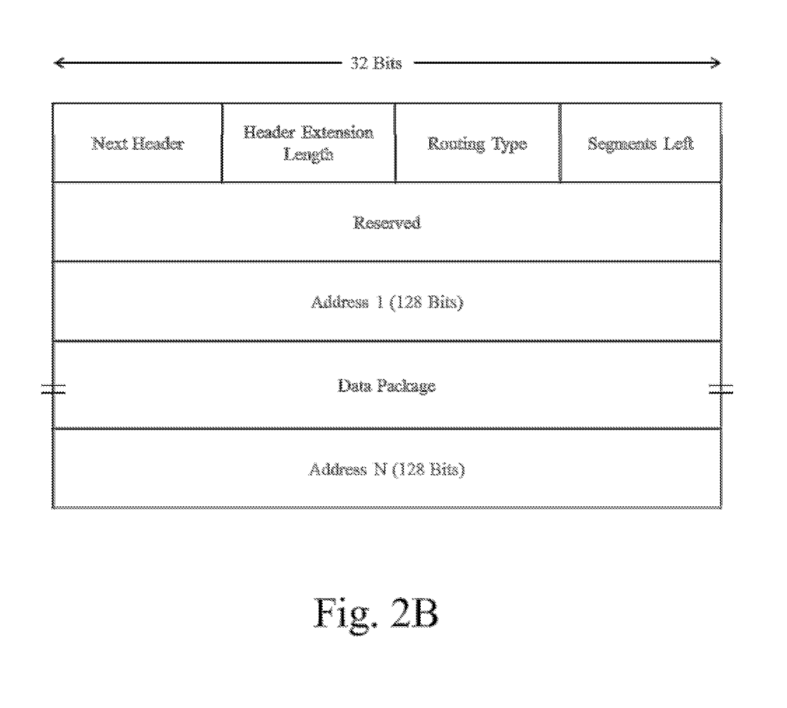

FIG. 2A, and 2B show the two current Internet protocol in use: IPv4 and IPv6. When a data package is sent via IPv4 (FIG. 2A), the destination address (IP address) is sent in the data package as part of the transmission. The public routers that receive the data packet will then use the IP address, along with their routing tables, to determine where to send the data package. The receiving router then does the same thing. This is repeated until the package reaches the destination IP.

At times this is efficient, at other times it is not favorable for VoIP transmissions. None of the routers change the IP address, but after each transmission (or re-transmission if there is an error in transmission), the IP header is modified to reflect the count change for the time

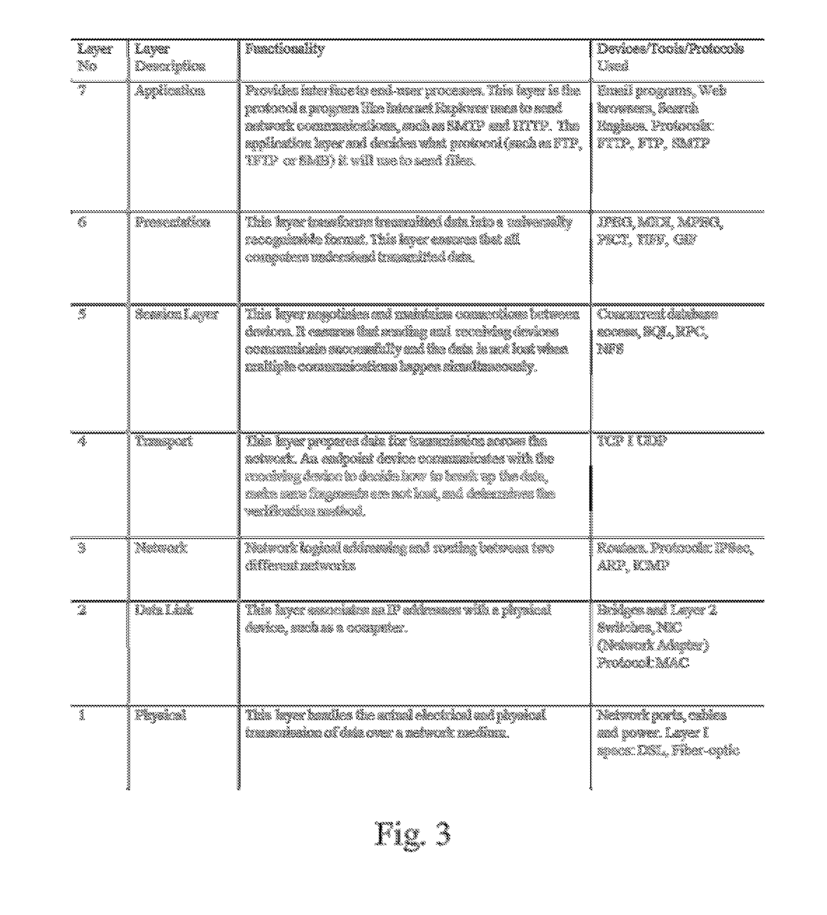

A description of the Internet layers is shown in FIG. 3. The communication to the routers from the central monitoring station happens between the Network and Transport levels (i.e. layers 3 and 4). The routing is done by routing tables established in the routers; the IP destination address is on the Internet protocol header.

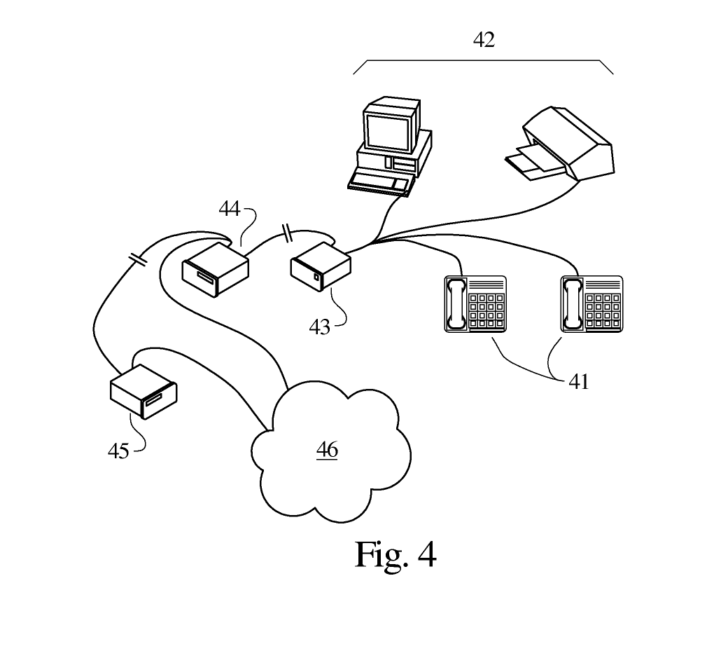

FIG. 4 shows a connecting setup 42 for a company or endpoint user. A Simple WAN is one choice for this system. Phones 41 are attached to a local LAN 42 which is connected to a network switch 43. This, in turn, is connected to a local border router 44, which connects directly to the Internet 46, or optionally, indirectly to the Internet through another border router 45 which is controlled by a VoIP service provider. Either the local border router or the VoIP router is able to receive routing tables from the monitoring facility. The routers also provide repackaging of the data packages, so as to facilitate routing through the Internet to the final endpoint. When received at the IP destination, the destination router strips out the repackage and views the original data packet to determine the final routing.

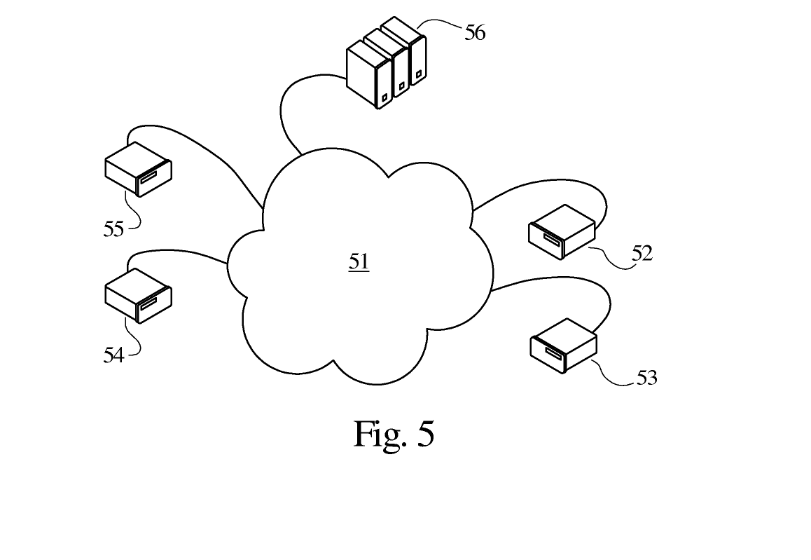

FIG. 5 shows a connecting setup between the Internet 51, the monitoring facility 56, and the VoIP routers 52-55 with routing tables controlled by the monitoring facility 56.

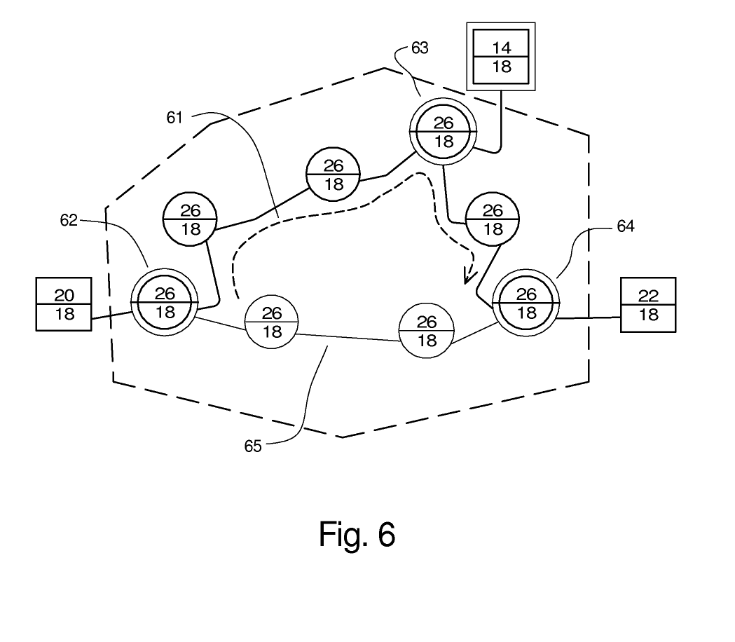

FIG. 6 shows a preferred path routing between two endpoints—a source point 20 and a final destination point 22. The monitoring facility 14 reviews data from connection routers 62-64, and dynamically sends out routing table instructions. The source point router 62 router is instructed to avoid Internet path 65 (which would be the normal path chosen by the connecting routers on Internet path 65). Instead, the source point router 62 repackages the data and sends it to border router 63 via a different destination IP on the repackage. The receiving router 63 strips the repackaging, and looks at the final destination endpoint. It then repackages (if necessary) the data packet and sends it to the final destination point router 64 which looks at the data packet and strips off any repackaging. It then sends it to the endpoint 22. In this example, repackaging is optional based on how the connecting routers on the Internet route the originating data packet. But when the monitoring facility decides a new path is preferred, the data packet has to be repackaged to send the data packet on the preferred, alternate route. Depending on the number of routers, the data packet can be repackaged a number of times, and the routers are programmed to intelligently strip out repackaging.

In FIG. 6, the connecting routers 62-64 are controlled by the monitoring facility 14, that is, their routing tables are controlled by the monitoring facility. In a typical case, the monitoring facility and connecting routers 62-64 are owned by the VoIP company providing service to the two endpoints, but this is not a strict requirement. The routing tables on connecting routers 62-64 may be owned by a different entity, but controlled by a contract with the VoIP company.

Though a VoIP system is generally described, it is only an example data packet that can be expedited by the prioritizing system taught herein. Any type of data packet can be routed through the Internet in the manner described and illustrated. This would include data packets for streaming entertainment, routing Internet pages, video conferencing, file transfers, video and audio data, etc. In this case, the class of service may be different and have different requirements, and the algorithm in the monitoring facility may establish different priorities for different classes of data.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A method for preferred routing on the Internet between two endpoints, comprising:
A) providing equipment comprising:
1) a plurality of routers capable of receiving and transmitting network data packets on the Internet, and
2) a monitoring facility which communicates with said routers,
B) wherein said monitoring facility receives identifying information from said routers and performs connectivity tests on data communications between said routers,
C) wherein said monitoring facility determines at least one preferred path for a data packet to be transmitted through the Internet from said routers to a defined endpoint,
D) wherein said monitoring facility compiles one or more routing tables based on said preferred path,
E) said routing tables are sent from said monitoring facility to said routers,
F) said routing tables are utilized by said routers when transmitting data packets,
G) said monitoring facility:
1) automatically repeats said connectivity tests,
2) redetermines at least one preferred path,
3) determines at least one update for at least one said routing table for at least one router, and
4) transmits any update to said routing tables to said routers as required, and
H) said routers repackage said data packet with a different IP address than a destination IP address according to any said routing tables.

2. The method of claim 1 wherein said identifying information includes at least one of:
A) a hardware identifier,
B) a network address,
C) a network identifier,
D) hardware temperature,
E) memory usage,
F) router uptime, and
G) bandwidth usage.

3. The system of claim 2, wherein said connectivity tests include at least one of:
A) determining a rate of data packet loss,
B) determining network latency, and
C) determining a hop count.

4. The system of claim 3, wherein said preferred path accomplishes at least one of:
(A) reducing data packet loss,
(B) reducing network latency, and
(C) lowers a path hop count.

5. The system of claim 4, wherein
A) said monitoring facility further comprises a network server accessible through the Internet and
B) said network server displays at least one of:
1) memory usage and
2) bandwidth usage.

6. The system of claim 1 wherein a virtual router is utilized to monitor data transmission.

7. A method for preferred VoIP and Video routing on the Internet between two endpoints, comprising:
A) providing equipment comprising:
1) a plurality of VoIP routers capable of receiving and transmitting network data packets on the Internet, and
2) a monitoring facility which communicates with said VoIP routers,
B) wherein said monitoring facility receives identifying information from said VoIP routers and performs connectivity tests on data communications between said VoIP routers,
C) wherein said monitoring facility determines at least one preferred path for a data packet to be transmitted through the Internet from said VoIP routers to a defined endpoint,
D) wherein said monitoring facility compiles one or more routing tables based on said preferred path,
E) said routing tables are sent from said monitoring facility to said VoIP routers,
F) said routing tables are utilized by said VoIP routers when transmitting data packets,
G) said monitoring facility:
1) automatically repeats said connectivity tests,
2) redetermines at least one preferred path,
3) determines at least one update for at least one said routing table for at least one said VoIP router, and
4) transmits any update to said routing tables to said VoIP routers as required, and
H) said VoIP routers repackage said data packet with a different IP address than a destination IP address according to said routing tables.
